(19) United States
(12) Patent Application Publication
(10) Pub. No.: US 2025/0112223 A1
(43) Pub. Date: Apr. 3, 2025

(54) SOLID-STATE BATTERY ANODE AND SOLID-STATE BATTERY

(71) Applicant: HONDA MOTOR CO., LTD., Tokyo (JP)

(72) Inventors: Kiyoshi TANAAMI, Saitama-ken (JP); Hiroshi SAKAI, Saitama-ken (JP); Toshimitsu TANAKA, Saitama-ken (JP)

(21) Appl. No.: 18/768,159

(22) Filed: Jul. 10, 2024

(30) Foreign Application Priority Data
Sep. 28, 2023 (JP) 2023-166682

(51) Int. Cl. H01M 4/133; H01M 4/02; H01M 4/48; H01M 4/587

(52) U.S. Cl. CPC H01M 4/133; H01M 4/48; H01M 4/587; H01M 2004/021; H01M 2004/027

(57) ABSTRACT

The present invention relates to a solid-state battery anode including: an anode current collector including a metallic porous body as a constituent material; and an anode active material with which the anode current collector is filled, in which a pore portion without the metallic porous body in a thickness direction from a surface on a solid-state electrolyte side is provided in the anode current collector, the pore portion has a pore diameter of 100 μm to 180 μm, and a depth in a thickness direction is larger than the pore diameter.

### BACKGROUND

### Technical Field

The present invention relates to a solid-state battery anode and a solid-state battery.

### Related Art

In these years, research and development on solid-state batteries that contribute to energy efficiency are conducted so that more people are able to access energy that is affordable, reliable, sustainable, and advanced. The solid-state batteries are high in energy density, and are used in a wide range of applications. In particular, lithium-ion secondary batteries that enable rapid charging and discharging are highly important as sustainable and advanced energy and also as power sources of electric vehicles (EV), hybrid electric vehicles (HEV), or the like.

As a configuration of a solid-state battery, there is a known configuration in which a current collector that constitutes an anode is made of foam metal in order to increase filling density of an electrode active material. JP 7008737 B2 discloses a semi-solid-state battery in which a porous coating layer is disposed on an electrode layer, as a semi-solid-state battery with foam metal used as a current collector. The porous coating layer in JP 7008737 B2 is capable of absorbing and trapping an electrolytic solution extruded from the electrode layer, even when an anode active material expands while the semi-solid-state battery is being charged, and is capable of suppressing a decrease in the electrolytic solution, a decrease in capacity due to repeated charging and discharging, and the like.

### CITATION LIST

### Patent Literature

Patent Literature 1: JP 7008737 B2

### SUMMARY

In order to contribute to further improvements in energy efficiency, the solid-state batteries are also demanded to be capable of maintaining the battery lives, also when charging and discharging are repeated. As demanded characteristics for this purpose, for example, when charging and discharging of the solid-state battery are repeated, lithium ions, sodium ions, and the like are controlled to receive electrons in the anode, and metallic lithium, metallic sodium, and the like are deposited on the anode. In a case where metallic lithium or the like is deposited on the anode, a gap is easily formed between layers, the resistance of the solid-state battery may increase, and an internal short circuit in which the cathode and the anode are electrically in contact with each other may also occur. In particular, in a high-capacity anode, metallic lithium or the like is likely to be deposited.

Under such a background, the present invention provides an anode that is less likely to cause an internal short circuit or the like due to deposition of metallic lithium or the like, while filling density of an electrode active material is equal to or larger than a predetermined value, in a case where the anode is used in a solid-state battery. In addition, provision of such an anode of the solid-state battery contributes to further improvements in energy efficiency of the solid-state battery.

To achieve the above-described object, the present invention provides the following means.

[1] A solid-state battery anode includes: an anode current collector including a metallic porous body as a constituent material; and an anode active material with which the anode current collector is filled, wherein a pore portion without the metallic porous body in a thickness direction from a surface on a solid-state electrolyte side is provided in the anode current collector, and the pore portion has a pore diameter of 100 μm to 180 μm.

In the anode of [1], when metallic lithium or the like is deposited on the anode, metallic lithium or the like is likely to be deposited inside the pore portions in a concentrated manner, and metallic lithium or the like deposited on the anode interface or the like is easily suppressed. Therefore, in a case where the anode of [1] is used in the solid-state battery, the battery life is less likely to decrease, even though charging and discharging are repeated while the amount of the anode active material per unit area of the anode is set to be equal to or larger than a predetermined value.

[2] The solid-state battery anode described in [1], wherein a ratio of a total volume of the pore portion to a porosity of the metallic porous body (a total volume of the pore portion/the porosity) is equal to or smaller than 10 vol %.

The anode in which the ratio of the total volume of the pore portions falls within the above range easily maintains high energy density as a solid-state battery. If the ratio of the total volume of the pore portions is too large, it will be difficult to maintain a high amount of the anode active material, and the energy density tends to decrease. This is because the capacity of the pore portions becomes excessively larger than the volume of the charged and deposited metallic lithium or the like, and it is difficult to maintain the height of the energy density due to the anode active material with which the metallic porous body is filled.

[3] The solid-state battery anode described in [1] or [2], wherein a ratio of a total volume of the pore portion to a porosity of the metallic porous body (a total volume of the pore portion/the porosity) is equal to or smaller than 8 vol %.

The solid battery including the anode of [3] easily maintains higher energy density. As illustrated in FIG. 3 to be described later, according to the inventors of the present invention, in the case where the ratio of the total volume of the pore portions to the porosity is equal to or smaller than 8 vol %, it becomes possible to suppress a decrease in energy density in a more reliable manner.

[4] The solid-state battery anode described in one of [1] to [3], wherein the pore portion has a depth equal to or larger than 3 μm in the thickness direction.

The pore portion has a depth equal to or larger than the above depth. Thus, a deposition space, when metallic lithium or the like is charged and deposited, tends to be ensured in a reliable manner, and a solid-state battery having high energy density is easily obtained.

[5] The solid-state battery anode described in one of [1] to [4], wherein the pore portion has a depth equal to or larger than 5 μm in the thickness direction.

The pore portion has a depth equal to or larger than the above depth. Thus, a deposition space for lithium or the like, when metallic lithium or the like is charged and deposited, tends to be easily ensured in a reliable manner, and a solid-state battery having higher energy density is easily obtained.

[6] The solid-state battery anode described in one of [1] to [5], wherein the pore portion serves as a through hole.

In a case where the pore portion is a through hole, lithium ions or the like tend to be uniformly supplied to the pore portions, metallic lithium or the like is stably deposited in the pore portion, and a cycle characteristic tends to be more easily maintained.

[7] The solid-state battery anode described in one of [1] to [6], wherein the pore portion has a cross-sectional shape of either a circle or quadrangle.

In a case where the cross-sectional shape of the pore portion is a circle, metallic lithium or the like is easily deposited in the pore portion in a stable manner. In addition, in a case where the cross-section of the pore portion is a quadrangle, a specific surface area per volume of the pore portion increases. Therefore, for example, at the time of rapid charging or the like, deposition of metallic lithium or the like in the pore portion in early stages is easily formed in a stable manner.

[8] The solid-state battery anode described in one of [1] to [7], wherein the anode active material includes a silicon-based material.

The above-described anode is suitably used, in a case where the anode active material is a silicon-based material.

[9] A solid-state battery including the anode described in one of [1] to [8].

According to the solid-state battery including the above-described anode, it becomes possible to suppress a decrease in battery life due to deposition of metallic lithium or the like, while filling density of the electrode active material is equal to or larger than to a predetermined value.

### BRIEF DESCRIPTION OF DRAWINGS

FIG. 1 is an image view illustrating an anode and a solid-state electrolyte of a solid-state battery in the present embodiment;

FIG. 2 is an enlarged image view of a part of the anode in FIG. 1 in the present embodiment; and

FIG. 3 is a diagram indicating values of energy density with respect to a space ratio.

### DETAILED DESCRIPTION

Hereinafter, preferred embodiments of the present invention will be described in detail with reference to the accompanying drawings.

### [Solid-State Battery Anode]

An anode of a solid-state battery in the present embodiment includes an anode current collector including a metallic porous body as a constituent material, and an anode active material with which the anode current collector is filled. In the anode current collector, pore portions that do not include the metallic porous body in a thickness direction from a surface on a solid electrolyte side, and the pore portions each have a pore diameter 100 μm to 180 μm.

The anode in the present embodiment is used in a solid-state battery having a structure in which a solid-state electrolyte is added between a cathode and an anode. It is known that the solid-state batteries have advantages in that the risk of burning is low, rapid charging is possible, it is less likely to degrade, the life is long, and the like. The structure of the solid-state battery is not particularly limited, and the solid-state battery may have any configuration such as a winding type of a cylindrical or rectangular shape or a laminated layered type.

With regard to the anode in the present embodiment, its battery life is less likely to decrease, also in a case where it is used in a solid-state battery and charging and discharging are repeated. In this respect, in the solid-state battery, a short circuit phenomenon that occurs when metallic lithium or the like is deposited on the anode is more likely to occur than in the secondary battery in which the electrolyte is a liquid, because of the following reasons. On the other hand, in the anode in the present embodiment, deposition of metallic lithium or the like on an anode interface or the like is easily suppressed, and thus the battery life hardly decreases even in the solid-state battery.

In the solid-state battery, the short circuit phenomenon that occurs when metallic lithium or the like is deposited on the anode interface or the like is considered to occur because of the following reasons. In the solid-state battery, the anode and the solid-state electrolyte layer form an interface between solid bodies. When metallic lithium is deposited, lithium ions are hardly conductive in the interface between the anode and the solid electrolyte in the deposition place, thereby leading to a situation in which the resistance also increases easily. Accordingly, a crack easily occurs in the electrode or the solid electrolyte layer, and it becomes difficult to function as a cell. The deposited metallic lithium enters a gap in the solid electrolyte layer, thereby easily causing the short circuit phenomenon.

On the other hand, in a secondary battery in which the electrolyte is a liquid, even though a crack occurs in the electrode, the liquid electrolyte enters the crack, and it is possible to maintain the conductivity of the lithium ions or the like. In addition, even though metallic lithium or the like is deposited between an electrode and a separator, the short circuit phenomenon does not occur, until the separator is broken. Thus, the time until the short circuit occurs is longer than that of a solid-state battery.

In addition, the solid-state battery including the anode in the present embodiment is suitably used in a lithium-ion secondary battery including a cathode, an anode, a solid-state electrolyte, and any other battery element, as necessary. The lithium-ion secondary batteries are applicable to a wide range of applications such as mobile telephones, mobile devices such as notebook computers, and in-vehicle applications. It is sufficient if the lithium-ion secondary battery has the configuration including the anode in the present embodiment. With regard to the configuration other than the anode, battery elements in a known lithium-ion secondary battery may be adopted without change. With regard to the configuration of the lithium-ion secondary battery, an example includes a lithium-ion secondary battery in which the anode in the present embodiment, a cathode that faces the anode, and a solid electrolyte layer located between the cathode and the anode are layered.

### (Anode Current Collector)

An anode current collector includes a metallic porous body as a constituent material. The metallic porous body is not particularly limited, as long as it is a metal material with a porous space generated by foaming. The metal that constitutes the metallic porous body may be, for example, nickel, a nickel-chromium alloy, aluminum, stainless steel, titanium, copper, silver, or the like. Copper or stainless steel is preferable.

The anode current collector including the metallic porous body as a constituent material is large in surface area. The surface area of the anode current collector is not particularly limited, but is preferably 1000 m²/m³ to 6000 m²/m³. Therefore, by filling the anode current collector with an electrode mixture containing the anode active material, it is possible to increase the amount of the active material per unit area of the electrode layer. Therefore, in a case where the anode in the present embodiment is used in a solid-state battery, it is high in energy density. In addition, in a case where the anode current collector includes the metallic porous body, an active material layer that is thick is easily formed without thickening the electrode mixture. Therefore, in a case where the anode in the present embodiment is used in the solid-state battery, a high capacity is easily achieved.

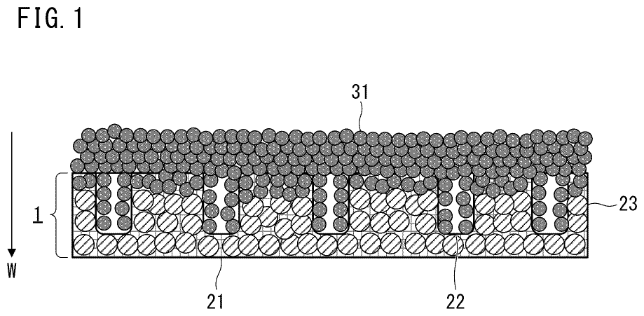

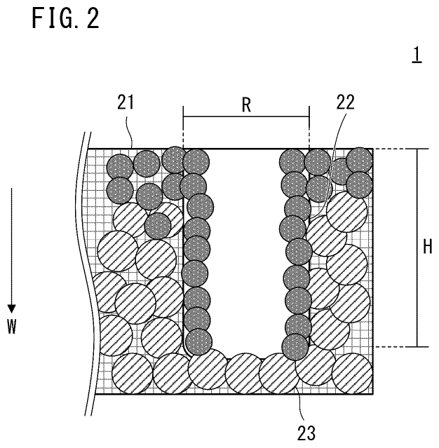

It is assumed that a pore portion is provided on the anode current collector. The pore portion of the anode current collector will be described with reference to the image views of FIGS. 1 and 2. In FIG. 1, an anode current collector 21 of an anode 1 is filled with an anode active material 23. Pore portions 22 are provided in the anode current collector 21 in a thickness direction W from a surface on a solid electrolyte 31 side. The pore portions 22 do not include a metallic porous body that constitutes the anode current collector 21, that is, the pore portions 22 are each a space (gap) without a skeleton of the metallic porous body. Note that in a case where the pore portion 22 is used in a solid-state battery, a deposited material of metallic lithium may be present in the inside.

The anode including the anode current collector including the pore portions is high in energy density as a solid-state battery, and the reasons are as follows. As the solid-state battery, when it is repeatedly charged and discharged, lithium ions and electrons present in the vicinity of the anode easily pass into the inside of the pore portions along a metal skeleton of the anode current collector and the solid-state electrolyte particles. Such lithium ions are likely to be deposited stably, as metallic lithium inside the pore portions. In such a solid-state battery, the deposition position of lithium can be controlled, as compared with a conventional solid-state battery in which metallic lithium is deposited at random positions in the anode. Therefore, an internal short circuit or the like that has been caused by deposition of metallic lithium in the conventional solid-state battery is suppressed. A solid-state battery that is high in cycle characteristic is obtained.

A pore diameter R is 100 μm to 180 μm, and is preferably 120 μm to 180 μm. If the pore diameter R is too small, it will be necessary to increase the number of pore portions in order to maintain the space in which metallic lithium is deposited, and the strength of the anode current collector will be likely to decrease. If the pore diameter R is too large, the surface area of the metallic porous body will be small, and it will be difficult to maintain the height of the energy density. In addition, the pore diameter R is a diameter (inner diameter) of a circle, in a case where the shape in cross-section (cross-sectional shape) of the pore portion in a horizontal direction (hereinafter, referred to as a “horizontal direction”) orthogonal to the thickness direction W is a circle, and is a diameter of an inscribed circle, in a case where the cross-sectional shape is a quadrangle. The pore diameter R in the present embodiment denotes an average value obtained by binarizing an image observed, from the solid electrolyte side surface of the anode current collector, with an electron microscope at a magnification of 50 times, and then calculating the average value from an image of the extracted pore portion.

The pore portion 22 preferably has a cross-sectional area in the horizontal direction of 6.0×10⁻⁵ cm² to 3.0×10⁻⁴ cm². If the cross-sectional area is too small, metallic lithium will be hardly deposited on the pore portions 22 in an appropriate manner, and if the cross-sectional area is too large, it will be difficult to maintain the height of the energy density as the solid-state battery.

The pore portion 22 preferably has a depth H in the thickness direction W to be larger than the pore diameter R (see FIG. 2). The depth H denotes a length from the surface on the solid electrolyte side of the anode current collector 21 to a tip end in the pore portion 22 (in a case where the pore portions 22 are through holes, the thickness of the through holes is equal to the film thickness of the metallic porous body in the thickness direction W). In a case where the depth H of the pore portion 22 is larger than the pore diameter R, the anode is obtained in which metallic lithium is easily deposited stably inside the pore portion, while a sufficient filling amount of the anode active material 23 is ensured. In addition, from the viewpoint of enabling to ensure a sufficient capacity for depositing metallic lithium inside the pore portion 22, the depth H of the pore portion 22 in the thickness direction W is preferably equal to or larger than 3 μm, and is particularly preferably equal to or larger than 5 μm.

The number of the pore portions 22 (the number of pores) provided in the anode current collector is not particularly limited. From the viewpoint of easily ensuring the sufficient capacity for depositing metallic lithium inside the pore portion 22, the number of the pore portions is preferably equal to or larger than two (pore portions/cm²), and is more preferably equal to or larger than five (pore portions/cm²) in the surface area of the anode current collector 21. From the viewpoint of easily maintaining the strength of the anode current collector, the number of pore portions is preferably equal to or smaller than ten (pore portions/cm²), and is more preferably equal to or smaller than nine (pore portions/cm²) in the surface area of the anode current collector 21.

As described above, the pore portion 22 preferably has an internal volume in which metallic lithium can be deposited sufficiently. On the other hand, if the internal volume of the pore portion 22 is excessive, an unnecessary space in which metallic lithium is not deposited will be held. In this case, in the anode, it tends to be difficult in maintaining the filling amount of the anode active material and maintaining the height of the energy density as a solid-state battery. In this regard, in a case where the anode in the present embodiment is used in a solid-state battery, the amount of metallic lithium deposited on the anode current collector 21 varies depending on the configuration of the cell, the current value at the time of charging, or the like. In consideration of such a variation due to the configuration of the solid-state battery, the pore diameter R of the pore portion 22 is preferably equal to or smaller than 2 L (R≤2 L) with respect to a lithium growth rate L (μm/h), when charged at 1 C. The anode 1, which has the pore diameter R within the above range, and which is provided in the anode current collector 21, can be made to have high energy density capable of coping with rapid charging and high output as a solid-state battery. The lithium growth rate L when charged at 1 C is obtained by calculating a value of the growth amount of deposited lithium, when constant current charging is conducted at 1 C until reaching a specified capacity 3 mAh/cm², and converting the calculated value into a value per hour. The pore diameter R in the present embodiment is preferably determined with the lithium growth rate L of 50 μm/h to 90 μm/h used as a reference.

The ratio of the total volume of the pore portions to the porosity of the metallic porous body (total volume of pore portions/porosity) is preferably equal to or smaller than 10 vol %, and is particularly preferably equal to or smaller than 8 vol %. It can be said that the total volume of the pore portions 22 is a space provided for deposition of metallic lithium. Therefore, in a case where the ratio of the total volume of the pore portions 22 to the porosity of the metallic porous body falls within the above range, higher energy density is easily maintained as a solid-state battery. The lower limit value of the above ratio is not limited. However, from the viewpoint of easily ensuring a deposition space for metallic lithium, it is preferably equal to or larger than 1 vol %, and is particularly preferably equal to or larger than 5 vol %. It is possible to measure the porosity (pore ratio) of the anode current collector 21 in a gas adsorption method or a mercury porosimeter method. The total volume of the pore portions is obtained by multiplying the volume per pore portion by the number of pore portions. It is possible to calculate the volume per pore portion from a depth and a cross-sectional area, or a depth, a cross-sectional shape, and a pore diameter, which are measured with an electron microscope by observing a pore portion cut in the horizontal direction with an argon beam or the like.

With regard to the deposition of metallic lithium in the pore portion 22, in a case where the deposition uniformly progresses on an inner surface of the pore portion 22, metallic lithium stably grows and the cycle characteristic is easily maintained as a solid-state battery, as compared with a case where the deposition uniformly progresses depending on the location. From the viewpoint of uniform deposition of metallic lithium in the pore portion 22, the pore portion 22 is preferably a through hole. In a case where the pore portion 22 is a through hole, lithium ions easily enter the pore portion 22 uniformly from a vertical direction of the pore portion 22. Therefore, metallic lithium is uniformly deposited in a more stable manner than a case where the pore portion 22 has a bottom surface.

In addition, the cross-sectional shape of the pore portion 22 (the shape in the horizontal direction when the pore portion 22 is observed from the solid electrolyte side) is not particularly limited, and may be a circle, an ellipse, a quadrangle, a polygon, a star, or the like. The cross-sectional shape of the pore portion 22 is preferably a circle or a quadrangle. In a case where the cross-sectional shape is a circle, lithium is easily deposited uniformly on the pore portion 22, and the cycle characteristic is easily maintained as a solid-state battery. In a case where the cross-sectional shape of the pore portion 22 is a quadrangle, it is possible to increase a specific surface area inside the pore portion 22. Therefore, when the solid-state battery is rapidly charged or the like, lithium deposition in early stages progresses easily. Note that in a case where the cross-sectional shape is an ellipse, the pore diameter corresponds to an arithmetic mean of the major diameter and the minor diameter. In a case where the cross-sectional shape is a polygon, the pore diameter corresponds to a diameter of an inscribed circle. In a case where the cross-sectional shape is a star, the pore diameter corresponds to a diameter of a circumscribed circle.

### (Anode Active Material)

The anode active material 23 is not particularly limited, and a battery element of a known solid-state battery can be adopted. Examples of the anode active material 23 include a silicon-based material, a carbon-based material, and a metal-based material. The anode 1 in the present embodiment is suitably used, in a case where the anode active material 23 is a high-capacity silicon-based material. Here, in a case where a silicon-based material is used as the anode active material 23, silicon easily expands and contracts when charging and discharging are repeated as a solid-state battery. For this reason, the anode active material 23 tends to slide down from the anode current collector 21, the interface becomes unstable, and deposition of metallic lithium is easily accelerated. On the other hand, in the anode 1 in the present embodiment, also in a case where the anode active material 23 including a silicon-based material, is used, metallic lithium is easily deposited on the pore portions 22 in a stable manner. In addition, the anode current collector 21 is a metallic porous body, and thus the anode active material 23 hardly slides down.

Examples of the silicon-based material of the anode active material 23 include SiOx (0<x<2) and a composite material Si—C of silicon and carbon. As the carbon-based material, for example, black lead (graphite), carbon nanotube, hardly graphitizable carbon (hard carbon), easily graphitizable carbon (soft carbon), low-temperature baked carbon, or the like may be used. Examples of the metal-based material include a lithium-based material, an aluminum-based material, a silicon-based material, and a tin-based material.

The anode active material 23 is preferably added at a ratio of 2 mg/cm² to 10 mg/cm² on the surface area of the anode current collector 21. If the filling amount of the anode active material 23 is too small, it will tend to be difficult to maintain high energy density, and also if the filling amount of the anode active material 23 is too large, it will be difficult to contribute to improvements of characteristics.

The anode current collector 21 may be filled with the anode active material 23 as an anode mixture containing a binder. As the binder, a known binder may be used, and examples include a fluororesin-based material. In addition, the anode mixture may contain a conductive auxiliary agent, as necessary.

### [Lithium-Ion Secondary Battery]

The anode in the present embodiment is suitably used for a lithium-ion secondary battery including an anode, a cathode, a solid electrolyte, and any other battery element, as necessary. A known battery element as a battery container or the like may be adopted for the lithium-ion secondary battery.

The solid electrolyte is not particularly limited, as long as it is a material capable of conducting lithium ions. As the solid electrolyte, for example, a polymer-based solid electrolyte of a polymeric compound containing at least one of a polyethylene oxide-based polymeric compound, a polyorganosiloxane chain, or a polyoxyalkylene chain, a sulfide-based solid electrolyte, or an oxide-based solid electrolyte can be used.

As the cathode, for example, a cathode in which a layer containing a cathode active material is formed on a cathode current collector may be adopted. The cathode active material is not particularly limited, and a known material may be applied. Examples of the cathode active material include a layered cathode active material particle, a spinel type cathode active material, and an olivine type cathode active material. The layer containing the cathode active material may contain a binder, a conductive auxiliary agent, a solid electrolyte, or the like. The binder and the conductive auxiliary agent are not particularly limited, and those known as materials of the solid-state battery may be applied.

### [Manufacturing Method of Anode]

It is possible to manufacture the anode in the present embodiment in a manufacturing method including: an anode active material filling step of filling, with an anode active material, an anode current collector including a metallic porous body as a constituent material; and a pore portion forming step of forming a pore portion in an anode precursor. Other manufacturing steps are not particularly limited, and a known method used as a method for manufacturing a solid-state battery may be applied.

### (Anode Active Material Filling Step)

The method for filling the anode current collector with the anode active material is not particularly limited, and a known method may be applied. Such a filling step may be, for example, a method for applying an anode mixture containing the anode active material to the inside of a gap in the anode current collector with use of a die coater or the like. The anode mixture may be applied in dipping coating, plunger type die coating, comma coating, blade coating, or the like, instead of die coating. From the viewpoint of easily maintaining high energy density, the coating amount of the anode active material on the anode current collector is preferably 2 mg/cm² to 10 mg/cm². The method in the present embodiment may further include a drying step of drying the anode current collector, after the anode active material filling step. The drying step is suitably performed under conditions of pressure of 100 MPa to 800 MPa and a drying temperature of 25° C. to 120° C.

### (Pore Portion Forming Step)

As the pore portion forming step, a known method may be applied, as long as the pore portion having the pore diameter and the depth described above can be formed in the anode current collector. The pore portion forming step may be, for example, a roll-press method for pressing with a roll having predetermined unevenness on the surface at predetermined pressure. By adjusting the shape and the depth of the unevenness provided on the roll and the pressing pressure, it becomes possible to form the pore portion having the pore diameter and the depth in the present embodiment.

### EXAMPLES

Next, examples of the present invention will be described. However, the present invention is not limited to the following examples.

### Example 1

As an anode current collector, foamed copper having thickness of 1 mm, a porosity of 98%, and a specific surface area of 5800 m²/m³ was prepared.

An anode mixture was prepared containing silicon (average particle size of 5 μm) as an anode active material, acetylene black as a conductive auxiliary agent, and styrene-butadiene rubber (SBR) as a binder. The anode current collector was filled with the prepared anode mixture with use of a die coater so that a coating amount is 10 mg/cm². The anode current collector after having been filled was dried in vacuum at 120° C. for 12 hours.

Next, the anode current collector was roll-pressed with a normal roll press machine at pressure of 500 MPa. Next, the anode current collector was roll-pressed at the pressure of 500 MPa with use of a roll, on which circular protrusions each having a diameter of 180 μm were arranged at an interval of 5.1 protrusions/cm². With regard to the pore portions formed in the anode current collector after having been roll-pressed, the average value of the pore diameters and the number of pore portions within a range of 100 times an observation visual field of an electron microscope were counted. In addition, the average value of the cross-sectional areas of the pore portions in the horizontal direction was calculated. Measurement results are indicated in Table 1 together with the measurement results of the following Examples and Comparative Examples.

### Examples 2 to 4

An anode, on which the pore portions were formed, was produced in a similar manner to Example 1, except that rolls, on which circular protrusions were respectively disposed at intervals of 4.6 protrusions/cm² (Example 2), 4.1 protrusions/cm² (Example 3), and 2.6 protrusions/cm² (Example 4), were used.

### Example 5

A cell design similar to Example 1 was conducted, except that the pore diameter in the anode was 100 μm and the number of pores was 9.2 pores/cm². A roll, on which circular protrusions each having a diameter of 100 μm were disposed, was used.

### Comparative Example 1

An anode current collector was produced in a similar manner to Example 1, except that a second roll-press was not conducted on the anode current collector that had been coated with the anode mixture and then dried. In the anode current collector of Comparative Example 1, it was not possible to observe a visible pore portion equal to or larger than 500 nm, when observed within a range of 100 times the visual field of an electron microscope.

### Comparative Example 2

A cell design similar to Example 1 was conducted, except that the pore diameter in the anode was 200 μm. An anode, on which the pore portions were formed, was produced in a similar method to Example 1, except that a roll, on which circular protrusions each having a diameter of 200 μm were disposed at an interval of 4.7 protrusions/cm², was used.

### Comparative Example 3

A cell design similar to Example 1 was conducted, except that the pore diameter in the anode was 80 μm. An anode, on which the pore portions were formed, was produced in a similar method to Example 1, except that a roll, on which circular protrusions each having a diameter of 80 μm were disposed at an interval of 10.8 protrusions/cm², was used.

With regard to the anodes in Examples and Comparative Examples that were produced as described above, processing accuracy and electrode strength were confirmed in the following measurement method.

### [Processing Accuracy]

The produced anode was cut into square size of 1 cm with an insulating ceramic blade, and was then cut in a horizontal direction with an argon beam (intensity: 4 kV, irradiation time: 12 hr, temperature: −60° C.) in vacuum with use of a cross-sectional amount generation device (JEOL Ltd., model number: IB-19530CP) to confirm processing performance. In addition, the cross-section that had been cut was observed with an electron microscope to confirm the cross-sectional shape of the pore portion in the horizontal direction and the depth of the pore portion. In Examples 1 to 5 and Comparative Example 2, circular cross-sectional shapes were observed. In Comparative Example 3, the metallic porous body was collapsed when it was cut, and it was not possible to confirm the cross-sectional shape after the processing. All of the pore portions of Examples 1 to 5 were through holes. Results of processing performance, and the cross-sectional shapes, the cross-sectional areas, and the depths of the pore portions are indicated in Table 1. The ratio of the total volume of the pore portions to the porosity of the anode current collector (total volume of pore portions/porosity) is also indicated in Table 1. The total volume of the pore portions was set with a value obtained by calculating the volume per pore portion from the average values of the cross-sectional areas and the depths and then multiplying the calculated volume by the number of pore portions. The processing performance was evaluated in accordance with the following criteria.

### <Evaluation of Processing Performance>

∘: Cutting was satisfactory, and it was possible to confirm the cross-section and the shape of the pore portion after processing.
Δ: At the time of processing, the pore portion was distorted by the argon beam, the shape of the pore portion was slightly deformed, and it was not possible to clearly confirm the pore portion.
x: The metallic porous body was collapsed when it was cut, cutting was not conducted satisfactorily, and it was not possible to confirm the shape of the cross-section or the like after processing.

### [Electrode Strength]

The anode that had been produced as described above was bent under the condition of a mandrel diameter of 32 mm with use of a bending tester (MTI Corporation, model number: EQ-MBT-12-LD), and the presence or absence of peeling of the anode active material or the like was confirmed. Results of the electrode strength that were evaluated in accordance with the following criteria are indicated in Table 1.

### <Evaluation of Electrode Strength>

∘: No peeling of the anode active material was observed.
Δ: Partial peeling of the active material was confirmed.
x: In addition to peeling of the active material, the structure of the electrode was collapsed.

### [Production of Lithium-Ion Secondary Battery]

Li(Ni_{0.6}Co_{0.2}Mn_{0.2})O₂ as a cathode active material, thio-LISICON (Li_{3.25}Ge_{0.25}P_{0.75S4}) as a solid electrolyte, acetylene black as a conductive auxiliary agent, styrene-butadiene rubber (SBR) as a binder, and butyl butyrate as a solvent were charged into a rotating and revolving mixer, stirred at 2000 rpm for three minutes, and then de-foamed for one minute to prepare a cathode mixture. The mass ratio of the cathode active material, the solid electrolyte, the conductive auxiliary agent, and the binder was 75:22:3:3. The cathode mixture was applied onto an aluminum foil as a cathode current collector and heated at 60° C. After heating, the roll-press was conducted, and a cathode including a cathode mixture layer having density of 3.1 g/cc and a basis weight of 26 mg/cm².

Next, thio-LISICON (Li_{3.25}Ge_{0.25}P_{0.75S4}) as a solid electrolyte was pressure powder molded at molding pressure of 150 MPa with use of a zirconium tube having a diameter of 10 mm, and a solid electrolyte layer having a diameter of 10 mm was obtained. A cathode having a diameter of 10 mm and a solid electrolyte layer were pressure molded at molding pressure of 1000 MPa, and a layered body of the cathode and the solid electrolyte layer (a layered body of cathode-solid electrolyte layer) were obtained.

The layered body of cathode-solid electrolyte layer obtained as described above and the anode of Example 1 were joined together at 60 MPa, and a lithium-ion secondary battery was produced. By using the anodes of Examples 2 to 5 and Comparative Examples 1 to 3, lithium-ion secondary batteries were produced in similar production methods.

### [Charging and Discharging Test]

The lithium-ion secondary battery that had been produced was CC charged up to 4.3 V at 0.05 C rate under a temperature condition of 60° C. After a resting time of ten minutes, a charging and discharging test was conducted at 0.05 C and a cutoff potential of 2.5 V. The charging and discharging test was started from charging. As results of the charging and discharging test using the lithium-ion secondary battery of each of Examples and Comparative Examples, the evaluation of the state of Li deposition and the energy density are indicated in Table 1. The state of Li deposition was evaluated, based on a charging and discharging curve in accordance with the following criteria.

### <Evaluation of Li Deposition>

∘: No peculiar fluctuation was confirmed in a charging curve.
Δ: In the charging curve, a voltage drop due to a minute short circuit was confirmed, but charging was enabled.
x: At the time of charging, a short circuit occurred due to abnormality of Li deposition, and sufficient charging was not enabled.
   [Li Growth Rate while Charging at 1 C]

With regard to the lithium-ion secondary battery of each of Examples and Comparative Examples, the growth rate in constant current charging at 1 C until reaching a specified capacity of 3 mAh/cm² was measured. Lithium deposition on the pore portions was confirmed with microscopic observation, and the growth of lithium was measured.

As results of the above measurements, in all Examples and Comparative Examples, the growth thickness of lithium per hour, that is, the growth rate of Li was 90 μm/h.

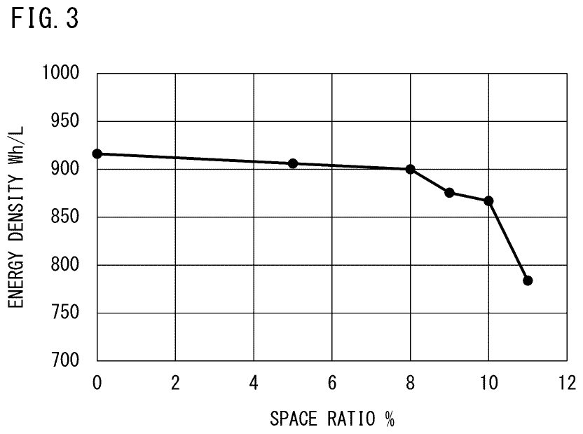

FIG. 3 illustrates a graph of results of the energy density with respect to a space ratio of the lithium-ion secondary battery in Example 1. Here, the space ratio denotes a ratio of the total volume of the pore portions to the porosity in the anode current collector.

TABLE 1

| | | | | | | | Comparative | Comparative | Comparative |
|---|---|---|---|---|---|---|---|---|---|
| | | Example 1 | Example 2 | Example 3 | Example 4 | Example 5 | example 1 | example 2 | example 3 |
| Pore | Pore | 180 | 180 | 180 | 180 | 100 | — | 200 | 80 |
| portion | diameter (μm) | | | | | | | | |
| | Cross-sectional | 2.35 × 10⁻⁴ | 2.35 × 10⁻⁴ | 2.35 × 10⁻⁴ | 2.35 × 10⁻⁴ | 7.85 × 10⁻⁵ | — | 3.14 × 10⁻⁴ | 5.03 × 10⁻⁵ |
| | area (cm²) | | | | | | | | |
| | The number of | 5.1 | 4.6 | 4.1 | 2.6 | 9.2 | — | 4.7 | 10.8 |
| | pores | | | | | | | | |
| | (number/cm²) | | | | | | | | |
| | Total volume of | 10 | 9 | 8 | 5 | 5 | 0 | 11 | 10 |
| | pore portions/ | | | | | | | | |
| | porosity | | | | | | | | |
| | (vol %) | | | | | | | | |

| | | | | | | | | |
|---|---|---|---|---|---|---|---|---|
| Li deposition | ◯ | ◯ | ◯ | ◯ | ◯ | X | Δ | ◯ |
| Energy density (Wh/L) | 867.8 | 877.2 | 902.0 | 907.0 | 907.0 | 917.0 | 786.3 | — |
| Processing accuracy | ◯ | ◯ | ◯ | ◯ | Δ | — | ◯ | X |
| Electrode strength | ◯ | ◯ | ◯ | ◯ | Δ | — | ◯ | X |

In Table 1, it was shown that all of the lithium-ion secondary batteries of Examples 1 to 5 had high energy density that exceeded 800 Wh/L. In the lithium-ion secondary battery of Comparative Example 1, the value of the energy density was high, but Li deposition was unstable. Thus, abnormal charging occurred when it was charged, a minute short circuit occurred, and stable charging and discharging was not enabled. For this reason, there is a possibility that an internal short circuit or the like occurs in the secondary battery of Comparative Example 1. The lithium-ion secondary battery of Comparative Example 2 was lower in energy density than Examples 1 to 5. In the lithium-ion secondary battery of Comparative Example 3, an electrode burst occurred in the charging and discharging test (measurement of the energy density was not enabled).

In addition, from FIG. 3, in a case where the ratio of the total volume of the pore portions to the porosity exceeded 8%, the energy density tended to decrease, and in a case where the ratio exceeded 10%, the energy density tended to significantly decrease. From such tendencies, it is considered that in the case where the ratio of the total volume of the pore portions to the porosity is equal to or smaller than 8%, the high energy density is easily maintained in a stable manner.

What is claimed is:

1. A solid-state battery anode comprising:
an anode current collector including a metallic porous body as a constituent material; and an anode active material with which the anode current collector is filled, wherein
a pore portion without the metallic porous body in a thickness direction from a surface on a solid-state electrolyte side is provided in the anode current collector, and
the pore portion has a pore diameter of 100 μm to 180 μm.

2. The solid-state battery anode according to claim 1, wherein a ratio of a total volume of the pore portion to a porosity of the metallic porous body is equal to or smaller than 10 vol %.

3. The solid-state battery anode according to claim 1, wherein a ratio of a total volume of the pore portion to a porosity of the metallic porous body is equal to or smaller than 8 vol %.

4. The solid-state battery anode according to claim 1, wherein the pore portion has a depth equal to or larger than 3 μm in the thickness direction.

5. The solid-state battery anode according to claim 1, wherein the pore portion has a depth equal to or larger than 5 μm in the thickness direction.

6. The solid-state battery anode according to claim 1, wherein the pore portion serves as a through hole.

7. The solid-state battery anode according to claim 1, wherein the pore portion has a cross-sectional shape of either a circle or quadrangle.

8. The solid-state battery anode according to claim 1, wherein the anode active material includes a silicon-based material.

9. A solid-state battery comprising the anode according to claim 1.
